(19) United States
(12) Patent Application Publication
(10) Pub. No.: US 2007/0074412 A1
(43) Pub. Date: Apr. 5, 2007

(54) Adjustable, Mobile, Vertical Practice Target Support Platform

(76) Inventor: Roert Kahute, Honeoye Falls, NY (US)

Correspondence Address: BROWN & MICHAELS, PC;400 M & T BANK BUILDING, 118 NORTH TIOGA ST, ITHACA, NY, 14850, US

(21) Appl. No.: 11/535,913

(22) Filed: Sep. 27, 2006

Related U.S. Application Data
(60) Provisional application No. 60/722,464, filed on Sep. 30, 2005.

(51) Int. Cl. G01C 15/06

(52) U.S. Cl. 33/293

(57) ABSTRACT

This mobile archery practice target platform has a support base with two upright vertical members adapted to fit into vertical sleeves in the base of an animal shaped archery target or an archery bag/block target support system. Wheels allow the base and any target and support system mounted on the vertical members to be towed from place to place, and the distance between the two upright vertical members is adjustable, allowing the base to be adjusted to fit different sized targets. In addition to use with 3-D archery animal targets, the base can support archery block and bag targets. This is accomplished by provision of support systems suitable to these two types of targets. These systems are also adjustable for use with different sizes of block and bag targets.

### REFERENCE TO RELATED APPLICATIONS

This application claims an invention which was disclosed in Provisional Application Number 60/722,464, filed Sep. 30, 2005, entitled “Adjustable, mobile, vertical, 3-D deer practice target practice platform and target taxi”. The benefit under 35 USC §119(e) of the United States provisional application is hereby claimed, and the aforementioned application is hereby incorporated herein by reference.

### TECHNICAL FIELD

This invention pertains generally to the fields of recreational archery and bow hunting. More particularly, it relates to an adjustable, mobile practice target support platform that is particularly adapted for use with 3-D deer and animal targets, but can also be adapted for use with other types of archery practice targets.

### BACKGROUND OF THE INVENTION

I have researched existing brands of 3-D deer targets extensively and concluded the following. Presently all brands of 3-D deer targets, as well as other 3-D animal targets are static in their function, design, and character. Existing 3-D deer targets typically and consistently use their front and rear molded-in foam legs with encapsulated metal tubes acting as vertical supports using separate ground anchor support rods embedded in the ground. This makes the various and existing 3-D deer targets static in their design, and difficult to relocate and reposition, thus limiting their usefulness.

### SUMMARY OF THE INVENTION

My invention is an adjustable, mobile practice target support platform that is particularly adapted for use with various sizes and types of 3-D deer targets (as well as other animal targets), but can also be adapted for use with other types of archery practice targets. It allows the archer to practice, both outdoors and indoors, and to have complete upright (vertical) 3-D deer target support and mobility for various brands of 3-D deer and 3-D animal targets.

It accomplishes the foregoing goals in part by providing for full size adjustment, making it easy to adjust for use with all existing brands of 3-D deer targets and other 3-D animal targets. In addition, it provides significant animal target mobility, positioning, storage, handling, and ease of transport. The aforesaid mobility advantages are primarily provided by inclusion of a lift-up/handle and of rear transport wheels in the target platform of the invention, allowing the invention with target to be easily moved to/from a storage location, and/or moved to and between different possible target positions. All of the features, in turn, significantly enhance the archer's 3-D deer target archery practice experience.

More specifically, my invention provides a mobile archery practice target platform that includes a support base holding two upright vertical members adapted to fit into the vertical sleeves commonly provided in the base of animal shaped archery targets.

Wheels at the back of the base allow the base and any target mounted on the upright vertical members to be towed while supported at least in part by said wheels (and a user handle may be advantageously provided at the front end to assist in this operation). The distance between the two upright vertical members is adjustable, allowing the platform to be adapted to support any type/size of animal or deer target having the aforesaid metal sleeves for mounting. And, in addition, I have provided and developed other archery target support systems that can be used with the platform to support archery bag and block targets for the same uses and purposes. These and other features and advantages of my invention are more fully explored in the detailed description that follows.

### DRAWING FIGURES

FIG. 1 provides a perspective view of a preferred embodiment of the invention.

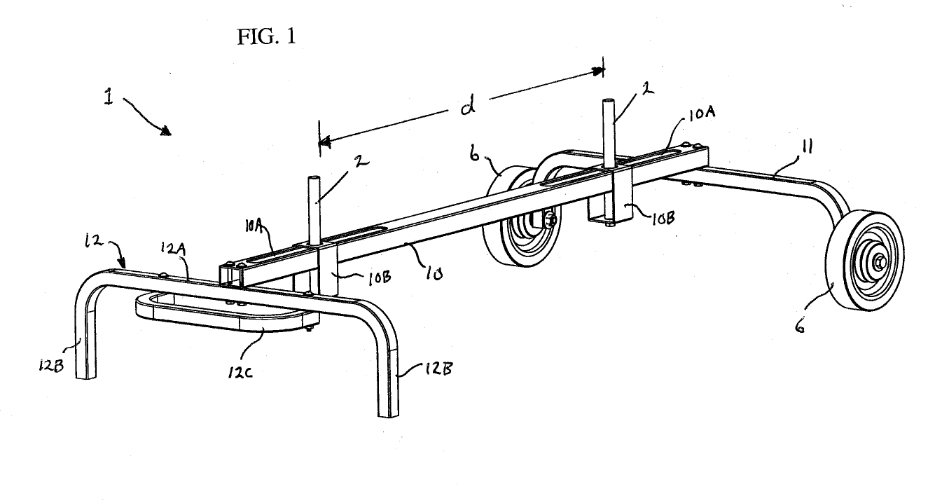

FIG. 2 provides an exploded perspective view of the preferred embodiment illustrated in FIG. 1.

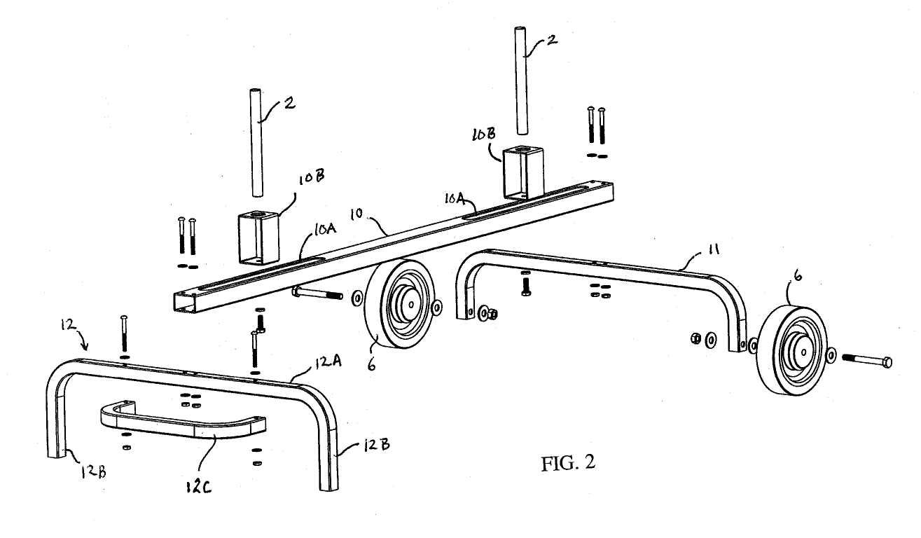

FIG. 3 provides a perspective semi-schematic view of an embodiment of the invention being used to hold and tow a 3-D animal target.

FIG. 4A provides a perspective view of the invention being used with a target support system adapted to hold (and holding) an archery bag target.

FIG. 4B provides a partially exploded view of the target support system and archery bag target of FIG. 4A.

FIG. 5A provides a perspective view of the invention being used with a target support system adapted to hold (and holding) an archery block target.

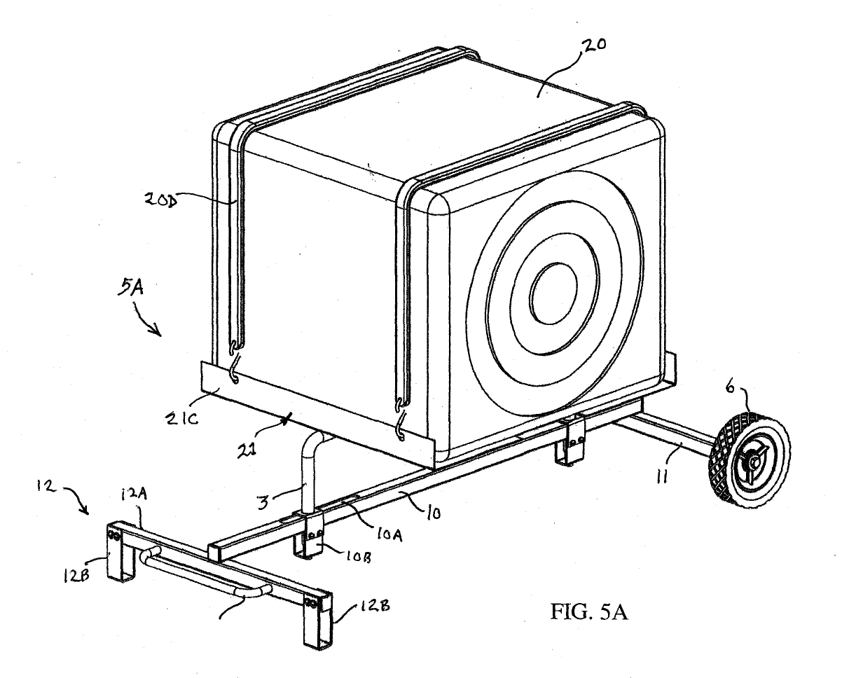

FIG. 5B provides a partially exploded view of the target support system and archery block target of FIG. 5A.

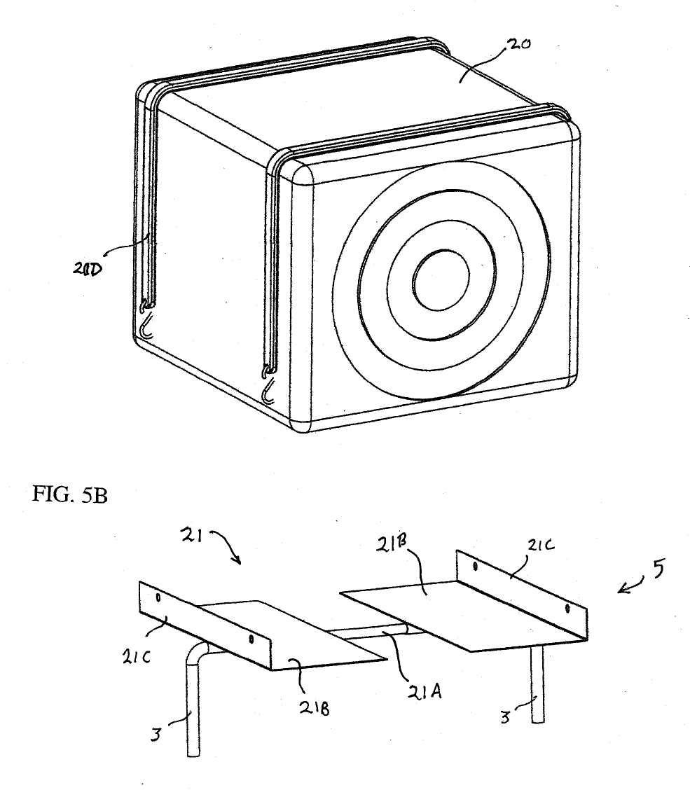

### DETAILED DESCRIPTION

Currently there is no known commercially available product in the marketplace that provides for an upright (vertical) support and allows for mobile transportation of a variety of existing brands of 3-D animal targets and/or other archery targets such as bag targets and block targets. When completely assembled, my invention provides for a complete upright (vertical) 3-D deer target support and mobility for a variety of brands of 3-D animal targets and other archery targets.

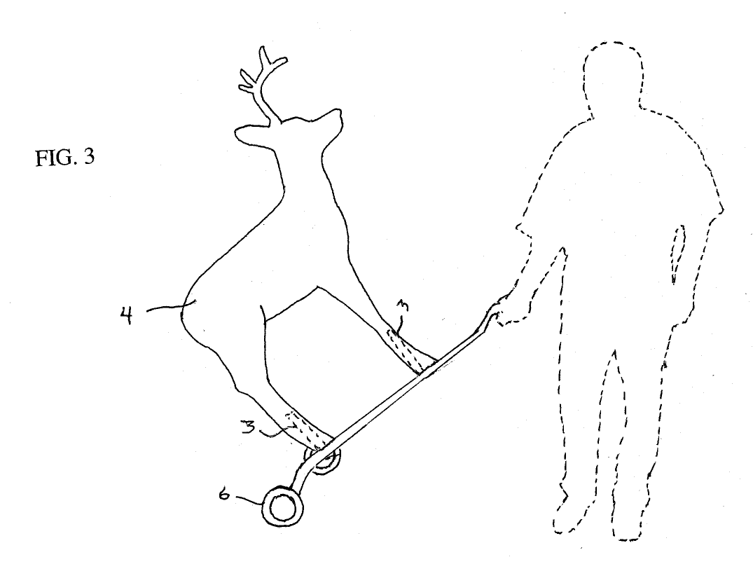

In its most basic preferred embodiments it can be described in general terms as a mobile archery practice target platform having a support base (denoted generally by arrow 1), with said support base 1 supporting two upright vertical members 2 slidably mounted thereto. These upright vertical members 2 are adapted to fit into vertical sleeves 3 in the base of at least one of an animal shaped archery target (e.g., such as deer target 4) and/or an archery target support system 5. These sleeves 3 have an internal diameter of approximately 0.625 inches, allowing them to easily slip over vertical members 2 (which have a diameter of approximately 0.562 inches, with clearance to spare. Wheels 6 at the rear of said base 1 allow the base 1 and any target 4 and/or support system 5 mounted on the upright vertical members 2 to be towed while supported at least in part by said wheels 6. (See, e.g., FIG. 3). A handle 12C can also be provided at the front of support base 1 to assist the user in this operation.

More specifically, as illustrated in the drawing figures, base 1 preferably includes a horizontal linear center frame member 10 and a horizontal rear cross frame member 11, with the vertical members 2 mounted on the center frame member 10. The wheels 6, previously described, are advantageously mounted at opposing ends of the rear cross frame member 11. And, adjustability for use with different sizes/types of targets 4 and target support systems 5 is provided by allowing the distance “d” between the two upright vertical members 2 to be varied by slidably mounting at least one (and preferably both) of said vertical members 2 to said center frame member 10. In the embodiments illustrated, vertical members slide in slots 10A that are approximately 7 inches in length (allowing “d” to very by approximately 14 inches) and are located on the upper and lower surfaces of center frame member 10. The fact that vertical members 2 extend through both sides of square center frame member 10 is of initial assistance in assuring their rigidity and support; however, they are also stabilized in their positions by rectangular braces 10B. I have found that both of these features working together produce a very stable and durable sliding configuration.

In addition, the embodiments illustrated include numerous other features and advantages. A front support (denoted generally by arrow 12) capable of supporting the support base and any target and target support system mounted thereon in a level horizontal position when not being towed is advantageously provided via a horizontal front cross frame member 12A with at least one downwardly extending leg 12B. In addition, archery target support systems 5A, 5B of my mobile archery support target platform are adapted to support at least one of an archery block target 20 and an archery bag target 30. The support system 5A for an archery block target includes an adjustable platform 21, while the support system 5B used for a bag target 30 includes an adjustable frame 31. In both cases, these have metal sleeve portions 3 adapted, as with the 3-D animal targets, to fit over and onto vertical members 2.

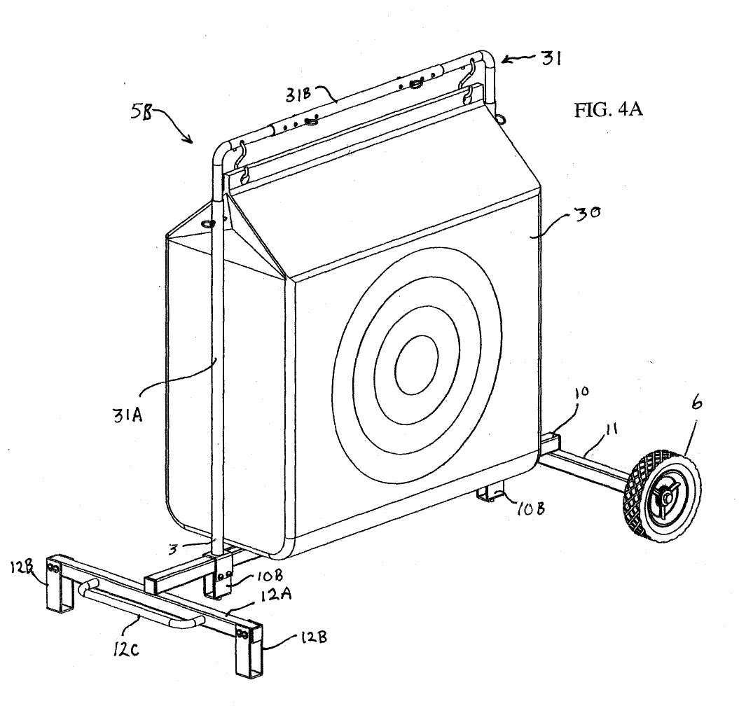

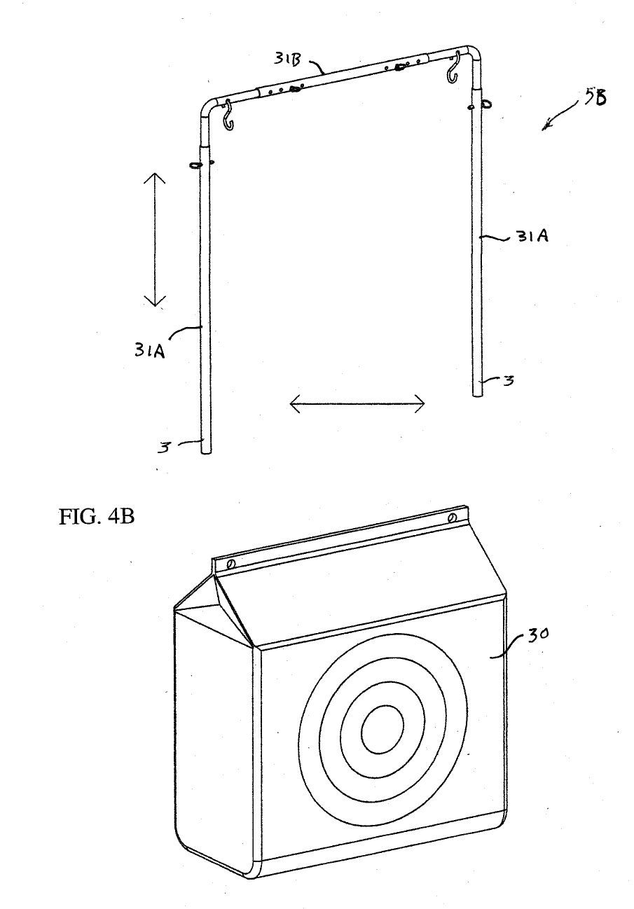

The adjustable frame 31 of the bag target support system 5B is adapted for use in hanging an archery bag target 30 from above (as illustrated in FIGS. 4A and 4B), and has upright members 31A and a telescoping horizontal support 31B. Both of these can be increased and decreased in size to adjust for different sized archery bag targets 30. Once adjusted to the proper size, they can be stabilized in their appropriate positions by an insertable pin-in-hole arrangement (as illustrated) or by other means well known in the mechanical arts. In contrast to this, the adjustable platform 21 of the block target support system is adapted for use in supporting an archery block target 20 from below. It has a telescoping horizontal brace 21A that ties together its two vertical sleeves 3, and supports a pair of platforms 21B adapted in size and shape to support archery box targets 20. An outer upward extending flange 21C on platforms 21B help to secure and hold a box target 20 in position and also provide a convenient locale for anchoring bungee cords 20D or other means of holding the box target 20 on platforms 21B. As with the prior system described, horizontal brace 21A can be increased and decreased in size to adjust for different sized archery block targets 20. As with the prior system, the box target support system allows for various sized targets to be positioned off the ground or other surfaces, providing longer product life and easy transportation.

However, numerous variations are possible without exceeding the inventive concept. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

I claim:

1. A mobile archery practice target platform, comprising:
(a) a support base, said support base supporting two upright vertical members mounted thereto, which upright vertical members are adapted to fit into vertical sleeves in the base of at least one of an animal shaped archery target and an archery target support system;
(b) wheels on said base, which wheels allow said base and any target and support system mounted on said upright vertical members to be towed while supported at least in part by said wheels; and
(c) wherein a distance between the two upright vertical members is adjustable.

2. The mobile archery practice target platform described in claim 1, wherein said base includes a horizontal linear center frame member and a horizontal rear cross frame member, which center frame member has said two upright vertical members mounted thereon.

3. The mobile archery practice target platform described in claim 2, wherein at least two of said wheels are mounted to said rear cross frame member.

4. The mobile archery practice target platform described in claim 2, wherein at least one of said two upright vertical members is slidably mounted to said center frame member.

5. The mobile archery practice target platform described in claim 1, further comprising at least one front support, which front support is capable of supporting the support base and any target mounted thereon in a level horizontal position.

6. The mobile archery practice target platform described in claim 5, wherein said front support includes a horizontal front cross frame member with at least one downwardly extending leg.

7. The mobile archery support target platform described in claim 1, further comprising at least one of an archery target support system and an animal shaped archery target.

8. The mobile archery support target platform described in claim 7, wherein said archery target support system is adapted to support at least one of an archery block target and an archery bag target.

9. The mobile archery support target platform described in claim 8 wherein said archery target support system includes at least one of an adjustable frame for the support of an archery bag target and an adjustable platform for support of an archery block target.

10. The mobile archery support target platform described in claim 9, wherein said adjustable frame is adapted for use in hanging an archery bag target from above, and has at least one of a telescoping upright member and a telescoping horizontal support which can be increased and decreased in size to adjust for different sized archery bag targets.

11. The mobile archery support target platform described in claim 9, wherein said adjustable platform is adapted for use in supporting an archery block target from below, and has a telescoping horizontal brace which can be increased and decreased in size to adjust for different sized archery block targets.

12. A mobile archery practice target platform, comprising:
(a) a support base, said support base including a horizontal linear center frame member and a horizontal rear cross frame member, which center frame member has two upright vertical members mounted thereon with at least one of said upright vertical members being slidable on said center frame member such that a distance between the two upright vertical members is adjustable, and which upright vertical members are adapted to fit into vertical sleeves in the base of at least one of an animal shaped archery target and an archery target support system; and
(b) wheels on said base, which wheels allow said base and any target and support system mounted on said upright vertical members to be towed while supported at least in part by said wheels, and which wheels are mounted to said rear cross frame member.

13. The mobile archery practice target platform described in claim 12, further comprising at least one front support, which front support is capable of supporting the support base and any target and target support system mounted thereon in a level horizontal position.

14. The mobile archery practice target platform described in claim 13, wherein said front support includes a horizontal front cross frame member with two downwardly extending legs.

15. The mobile archery support target platform described in claim 12, further comprising at least one of an archery target support system and an animal shaped archery target.

16. The mobile archery support target platform described in claim 15, wherein said archery target support system is adapted to support at least one of an archery block target and an archery bag target.

17. The mobile archery support target platform described in claim 16, wherein said archery target support system includes at least one of an adjustable frame for the support of an archery bag target and an adjustable platform for support of an archery block target.

18. The mobile archery support target platform described in claim 17, wherein said adjustable frame is adapted for use in hanging an archery bag target from above, and has at least one of a telescoping upright member and a telescoping horizontal support which can be increased and decreased in size to adjust for different sized archery bag targets.

19. The mobile archery support target platform described in claim 17, wherein said adjustable platform is adapted for use in supporting an archery block target from below, and has a telescoping horizontal brace which can be increased and decreased in size to adjust for different sized archery block targets.

20. A mobile archery practice target platform, comprising:
(a) a support base, said support base including a horizontal linear center frame member and a horizontal rear cross frame member, which center frame member has two upright vertical members mounted thereon with at least one of said upright vertical members being slidable on said center frame member such that a distance between the two upright vertical members is adjustable, and which upright vertical members are adapted to fit into vertical sleeves in the base of at least one of an animal shaped archery target and an archery target support system;
(b) wheels on said base, which wheels allow said base and any target and support system mounted on said upright vertical members to be towed while supported at least in part by said wheels, and which wheels are mounted to said rear cross frame member;
(c) at least one front support, which front support is capable of supporting the support base and any target and target support system mounted thereon in a level horizontal position; and
(d) at least one of an archery target support system and an animal shaped archery target.
